(19) United States
(12) Patent Application Publication
(10) Pub. No.: US 2022/0171920 A1
(43) Pub. Date: Jun. 2, 2022

(54) FORM FIELD HIGHLIGHTING AND REARRANGEMENT BASED ON INCIDENT IDENTIFICATION AND LOCATION

(71) Applicant: MOTOROLA SOLUTIONS, INC., CHICAGO, IL (US)

(72) Inventors: YONG TIAN, CHENGDU (CN); XUN FEI, CHENGDU (CN); DONG ZHAO, CHENGDU CITY (CN); GUAN YONG ZHOU, CHENGDU (CN); HAI-QING HU, CHENGDU (CN); JUN JIANG, CHENGDU (CN)

(21) Appl. No.: 17/432,499

(22) PCT Filed: Jun. 19, 2019
(86) PCT No.: PCT/CN2019/091896

§ 371 Date: Aug. 20, 2021

(51) Int. Cl. G06F 40/174; G06Q 50/26

(52) U.S. Cl. CPC G06F 40/174; G06Q 50/265

(57) ABSTRACT

A method and apparatus for presenting a form to a user is provided herein. During operation, an incident type is determined along with a current location of a public-safety officer. This information is used to modify a form for easier filling by the public-safety officer. More particularly, fields of the form are provided in an order based on the incident type and location. Alternatively, the fields of the form may be highlighted based on the incident type and location.

### BACKGROUND OF THE INVENTION

As part of a first responder's duties, various forms need to be filled out after every incident. Due to time constraints, many forms cannot be filled in their entirety while at a particular incident, leaving the remainder of the form to be filled at a later time. It would be beneficial for first responders if various fields of a form could be presented (or highlighted) to the first responder in a manner that would aide in filling out a form in the most efficient manner while at the incident scene.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an incident form.

FIG. 2 illustrates a modified incident form.

FIG. 3 illustrates a modified incident form.

FIG. 4 is a block diagram of an apparatus used to modify an incident form.

FIG. 5 is a flow chart showing operation of the apparatus of FIG. 4

FIG. 6 is a flow chart showing operation of the apparatus of FIG. 4

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for presenting a form to a user is provided herein. During operation, an incident type is determined along with a current location of a public-safety officer. This information is used to modify a form for easier filling by the public-safety officer. More particularly, fields of the form are provided in an order based on the incident type and location. Alternatively, the fields of the form may be highlighted based on the incident type and location.

Expanding on the above, a current incident type may be determined, and a particular form presented to an officer may be chosen based on the current incident type. Once the particular form is chosen, a determination of whether a public-safety officer is on scene or not may be determined and those fields that are best filled out at the scene are presented to the officer based on if the officer is on scene or not. For example, certain fields are arranged and shown at the front of the form, or highlighted in a different color when the officer is on scene.

Consider the following example: Officer Jones is patrolling an area when he is assigned to a bank robbery. Once officer Jones is assigned to the bank robbery, an electronic device in possession of Officer Jones will display a form related to bank robberies that will need to be filled out by Officer Jones. In particular, the form will have fields that need to be filled out by Officer Jones.

Once on scene, the fields of the form will be re-arranged and/or highlighted so that those fields that are easier to be filled out at the scene are presented first to officer Jones. In an alternative embodiment, the fields are highlighted. In yet a further embodiment of the present invention, the fields are both rearranged and highlighted. For example, fields like witness statements, current weather conditions, and physical appearances of objects/suspects on scene are better filled out when the Officer has access to the witnesses and object/suspects. Once Officer Jones leaves the scene, the rearranged/highlighted fields of the form are un-highlighted and placed back in their original order.

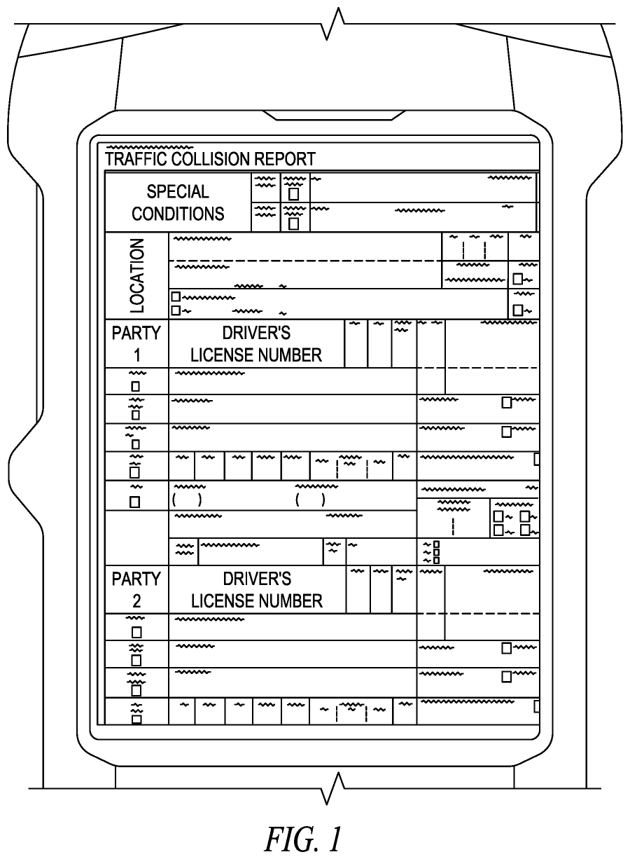

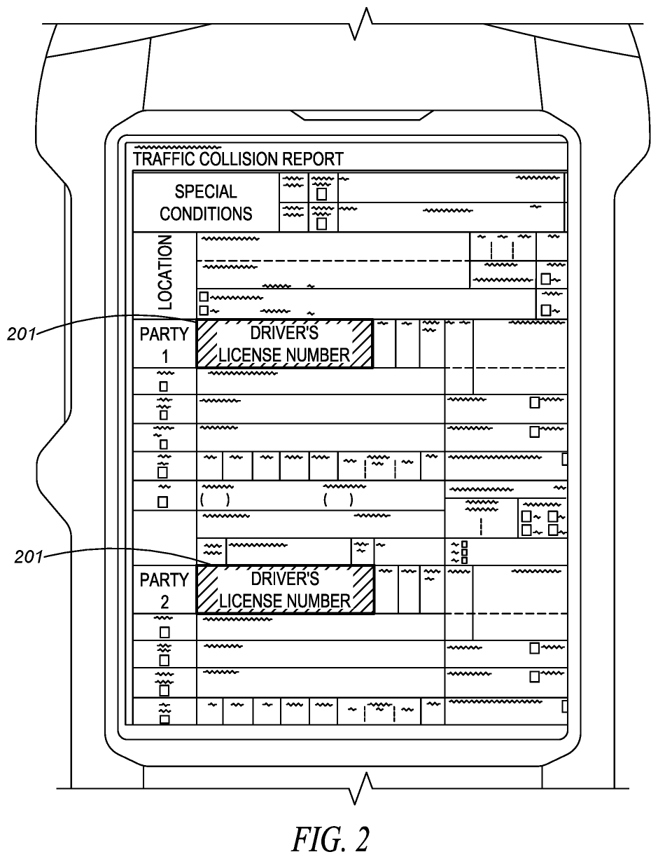

This is illustrated in FIG. 1 through FIG. 3. Shown in FIG. 1 is a traffic accident report to be filled out by an officer responding to a traffic accident. When the officer is at the scene of the accident, various fields are highlighted. This is shown in FIG. 2, with the form having highlighted fields 201. In this case, “driver's license number” is highlighted since it is easier to obtain this information on scene. When the officer leaves the incident scene, these fields will again remain un-highlighted.

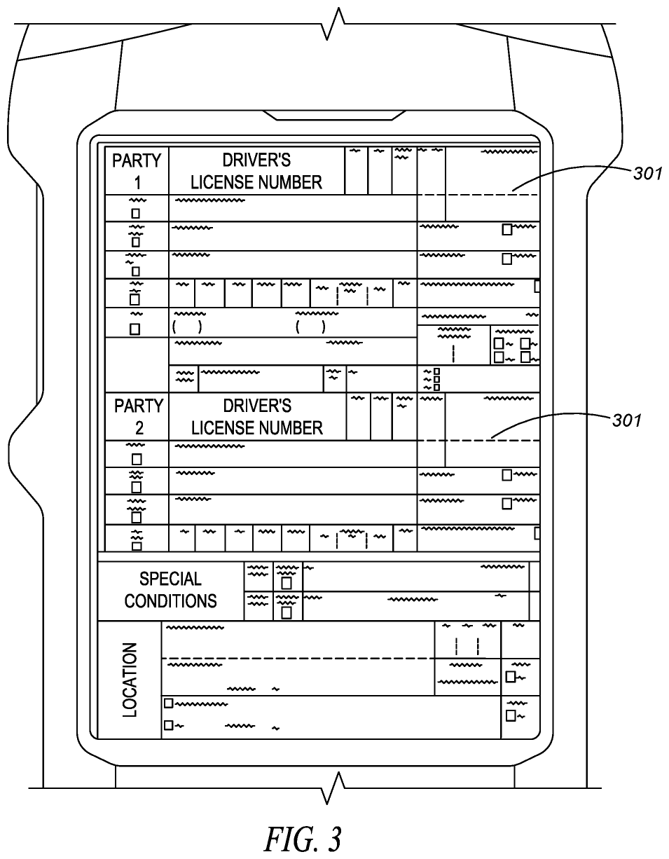

FIG. 3 is an illustration of how certain fields of a form may be re-arranged when at an incident scene. In this particular example, “Party 1” and “Party 2” information fields 301 are placed at the top of the form when on scene. Compare this to FIG. 1, where these fields are placed lower in the form when not on scene.

It should be noted that location data may be constantly be acquired for Officer Jones, and the location data used to update form fields as described above as Officer Jones moves about the incident scene. For example, if it is determined that Officer Jones is outside a building, fields requiring information regarding, for example, weather conditions, license plate numbers, . . . , etc. may be highlighted and/or presented to Officer jones first. If it is determined that Officer Jones is inside a building, then fields requiring information better obtained from inside the building may be highlighted and/or presented to Officer Jones first.

In an embodiment of the present invention, a computer-aided dispatch (CAD) incident identifier (ID) is utilized to determine a current task or incident assigned to an officer. An incident identification (sometimes referred to as an incident scene identifier, or a CAD identifier) is generated for incidents where an officer is dispatched. This ID could be something as simple as a number, or something as complicated as an identification that is a function of populated fields, one of which may comprise an incident type. Another field of the CAD_ID may comprise a location. The CAD_ID is utilized by a device to determine what form to present to an officer. For example, when the CAD_ID indicates that a vehicle accident has been assigned to an officer, then a vehicle accident report form may be presented to the officer. Likewise, when the CAD_ID indicates that a robbery investigation has been assigned to an officer, then a robbery report form may be presented to the officer. The CAD_ID may also be utilized to determine a location of the incident.

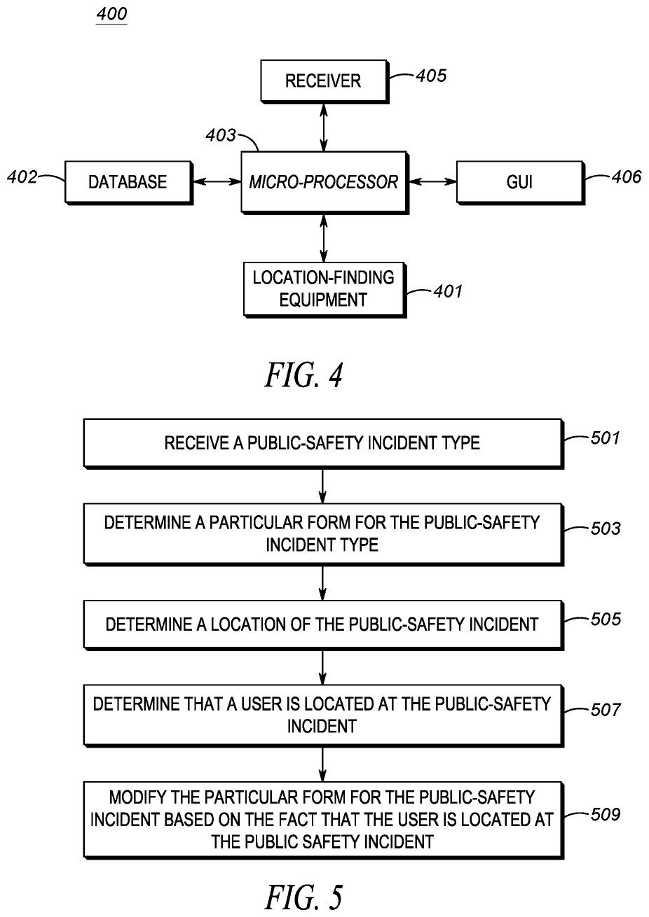

FIG. 4 is a block diagram of apparatus 400 for highlighting/rearranging fields of a form as described above. As shown apparatus 400 comprises location-finding equipment 401, database 402, logic circuitry 403, receiver 405, and graphical-user interface (GUI) 406. Apparatus 400 may a laptop computer, police radio, tablet computer, smartphone, or any other electronic device capable of rearranging a form as described herein.

GUI 406 provides a man/machine interface for receiving an input from a user and displaying information. For example, GUI 406 may provide a way of conveying (e.g., displaying) forms received from processor 203. GUI 406 also provides means for a user to input information into a displayed form. In order to provide the above features (and additional features), GUI 406 may comprise any combination of a touch screen, a computer screen, a keyboard, or any other interface needed to receive a user input and provide information to the user. An officer will use GUI 406 to not only view the form, but also fill out the form.

Database 402 comprises standard memory (such as RAM, ROM, . . . , etc.) and serves to store forms associated with various incidents (CAD_IDs). A first table comprising CAD_IDs and their associated forms may be stored within database 402 as well. Microprocessor 403 accesses database 402 and determines an appropriate form based on a CAD_ID by utilizing the stored first table. That form can then be retrieved from database 402. Database 402 also comprises a second table of high-priority fields for each CAD_ID. Thus, logic circuitry 403 can access database 402, determine an appropriate form for a particular incident (via first table), access the particular form, and determine high-priority fields within the form for that CAD_ID (via second table). The high-priority fields comprise those fields that will be highlighted or relocated when device 400 is at an incident scene. Alternatively, the second table may comprise fields that are to be highlighted when located in certain areas of an incident scene (e.g., outside or inside a building).

Location-finding equipment 401 preferably comprises standard equipment used to determine a location of device 400. For example, equipment 401 may comprise a standard global-positioning system (GPS) receiver used to access GPS satellites and determine a precise location. In alternate embodiments location-finding equipment 401 may comprise a simple user interface having means for a user to input information on their location. For example, equipment 401 may simply comprise a radio button on GUI 406 that a user may “press” when they are at an incident scene.

Receiver 405 is preferably wireless, and may be long-range and/or short-range receiver that utilize a private 802.11 network set up by a building operator, a next-generation cellular communications network operated by a cellular service provider, or any public-safety network such as an APCO 25 network or the FirstNet broadband network. Receiver 405 serves as a means form apparatus 400 to communicate with a dispatch center and receive an incident assignment/type along with a possible location of the incident.

Microprocessor 403 serves as logic circuitry, and comprises a digital signal processor (DSP), general purpose microprocessor, a programmable logic device, or application specific integrated circuit (ASIC) and is configured to determine a location of the officer from location-finding equipment 401, and determine if the location of the officer is at an incident scene assigned to the officer. Logic circuitry 403 also receives a CAD_ID from receiver 405 and retrieves (from database 402) a proper form based on the CAD_ID type from database 402. Alternatively, a user may access the proper form themselves without aide from logic circuitry 403. Finally, logic circuitry 403 outputs a modified form to GUI 406. The modified form may be temporarily stored in database 402. For example, logic circuitry 403 may receive a CAD_ID from a dispatch center, assigning a user to a traffic accident. The location of the traffic incident is also received by receiver 405. This location may be part of the CAD_ID, or alternatively may simply be communicated to the officer by the dispatch operator. Logic circuitry 403 accessed location-finding equipment 401 and determines that device 400 is located at the incident scene (within a predetermined distance, e.g., 100 meters). This may be accomplished by logic circuitry 403 determining the location from the CAD_ID and comparing a current location obtained via equipment 401. Alternatively, this may be accomplished simply by a user notifying logic circuitry 403 that they have arrived at the incident scene. Logic circuitry 403 accesses a proper form from database 402, accesses high-priority fields from database 402, and modifies the form accordingly. The form is output by logic circuitry 403 to GUI 406 to be presented to the user of device 400.

Thus, as described, apparatus 400 comprises an over-the-air receiver configured to receive a public-safety incident type and a location of a public-safety incident, and logic circuitry configured to determine a particular form for the public-safety incident type, determine that a user is located at the public-safety incident, and modify the particular form based on the fact that the user is located at the public-safety incident.

As described, the public-safety incident type may be transmitted to the over-the-air receiver by a public-safety dispatch center, and the location of the public-safety incident may be transmitted to the over-the-air receiver by a public-safety dispatch center.

In one embodiment apparatus 400 also comprises a GPS receiver. The logic circuitry may determine that the user is located at the public-safety incident by accessing the GPS receiver to determine a location.

As discussed above, the logic circuitry may modify the particular form by highlighting certain fields of the form or by rearranging certain fields of the form.

FIG. 5 is a flow chart showing operation of apparatus 400. The logic flow begins at step 501 where receiver 405 receives a public-safety incident type. This may simply comprise a dispatch operator instructing an officer of the incident and/or receiving a CAD_ID. At step 503 logic circuitry 403 determines a particular form for the public-safety incident type and determines a location of the public-safety incident (step 505). At step 507, logic circuitry 403 determines that a user is located at the public-safety incident. This may comprise logic circuitry receiving the indication via a user (via GUI 406). Alternatively, this step may comprise logic circuitry accessing equipment 401 to determine a location and determine if the location is at the incident scene. Finally, at step 509, logic circuitry modifies the particular form for the public-safety incident based on the fact that the user is located at the public-safety incident. The modified form is then presented to a user via outputting the modified form the GUI 406.

As discussed, the step of receiving the public-safety incident type ma comprise the step of receiving the public-safety incident type at an over-the air receiver, the public-safety incident type transmitted to the over-the-air receiver by a public-safety dispatch center.

Additionally, the step of determining the location of the public-safety incident may comprise the step of receiving the location of the public-safety incident at an over-the air receiver, the location of the public-safety incident transmitted to the receiver by a public-safety dispatch center.

Additionally, the step of determining that the user is located at the public-safety incident may comprise the step of determining a location of the user from a GPS receiver.

Additionally, the step of modifying the particular form may comprise the step of highlighting certain fields of the form and/or rearranging certain fields of the form.

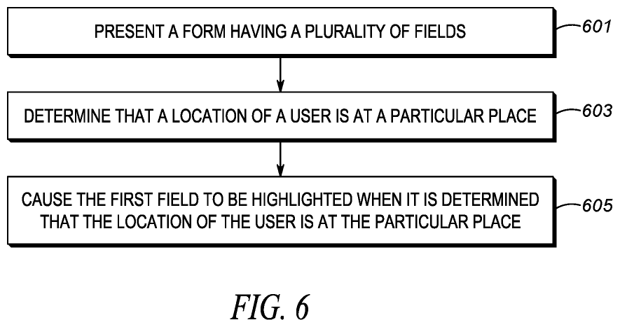

FIG. 6 is a flow chart showing operation of apparatus 400. The logic flow begins at step 601 where GUI 406 is presenting a form having a plurality of fields, wherein the plurality of fields includes at least a first field that is not highlighted. At step 603, logic circuitry 403 determines that a location of a user is at a particular place and causes the first field to be highlighted when it is determined that the location of the user is at the particular place (step 605). As discussed above, the particular place may comprise an incident scene. Additionally, the step of determining that the location of the user is at the particular place may comprise the step of receiving an indication from a user that the user has arrived at the particular place.

In the foregoing specification, specific embodiments have been described. However, one of ordinary skill in the art appreciates that various modifications and changes can be made without departing from the scope of the invention as set forth in the claims below. For example, while the present invention was described herein as arranging/highlighting fields of a form based on a location of a device being at an incident scene, one of ordinary skill in the art will recognize that this technique may be applied to various other locations. For example, forms for delivery truck drivers may be modified as described when at a delivery point; forms for airline pilots may be modified as described above when they reach their destination, . . . , etc. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for modifying a form, the method comprising the steps of:
receiving a public-safety incident type;
determining a particular form for the public-safety incident type;
determining a location of the public-safety incident;
determining that a user is located at the public-safety incident; and
modifying the particular form for the public-safety incident based on the user being located at the public-safety incident.

2. The method of claim 1 wherein the step of receiving the public-safety incident type comprises the step of receiving the public-safety incident type at an over-the-air receiver, the public-safety incident type transmitted to the over-the-air receiver by a public-safety dispatch center.

3. The method of claim 1 wherein the step of determining the location of the public-safety incident comprises the step of receiving the location of the public-safety incident at an over-the air receiver, the location of the public-safety incident transmitted to the receiver by a public-safety dispatch center.

4. The method of claim 1 wherein the step of determining that the user is located at the public-safety incident comprises the step of determining a location of the user from a GPS receiver.

5. The method of claim 1 wherein the step of modifying the particular form comprises the step of highlighting certain fields of the form.

6. The method of claim 1 wherein the step of modifying the particular form comprises the step of rearranging certain fields of the form.

7. An apparatus comprising:
an over-the-air receiver configured to receive a public-safety incident type and a location of a public-safety incident; and
logic circuitry configured to determine a particular form for the public-safety incident type, determine that a user is located at the public-safety incident, and modify the particular form when the user is located at the public-safety incident.

8. The apparatus of claim 7 wherein the public-safety incident type is transmitted to the over-the-air receiver by a public-safety dispatch center.

9. The apparatus of claim 7 wherein the location of the public-safety incident is transmitted to the over-the-air receiver by a public-safety dispatch center.

10. The apparatus of claim 7 further comprising:
a GPS receiver; and
wherein the logic circuitry determines that the user is located at the public-safety incident by accessing the GPS receiver.

11. The apparatus of claim 7 wherein the logic circuitry modifies the particular form by highlighting certain fields of the form.

12. The apparatus of claim 7 wherein the logic circuitry modifies the particular form by rearranging certain fields of the form.

13. A method comprising the steps of:
presenting a form having a plurality of fields, wherein the plurality of fields includes at least a first field that is not highlighted;
determining that a location of a user is at a particular place; and
highlighting the first field when it is determined that the location of the user is at the particular place.

14. The method of claim 13 wherein the particular place comprises an incident scene.

15. The method of claim 13 wherein the step of determining that the location of the user is at the particular place comprises the step of receiving an indication from a user that the user has arrived at the particular place.
